(19) United States
(12) Patent Application Publication
(10) Pub. No.: US 2024/0233554 A1
(43) Pub. Date: Jul. 11, 2024

(54) AEROPHOTOGRAPHY FLIGHT DIRECTOR

(71) Applicant: Phase One A/S, Frederiksberg (DK)

(72) Inventor: Ehud MENAKER, Maccabim-Reut (IL)

(73) Assignee: Phase One A/S, Frederiksberg (DK)

(21) Appl. No.: 18/143,129

(22) Filed: May 4, 2023

Related U.S. Application Data
(60) Provisional application No. 63/437,766, filed on Jan. 9, 2023.

(51) Int. Cl. G08G 5/00; B64D 43/00; G01C 23/00

(52) U.S. Cl. CPC G08G 5/003; B64D 43/00; G01C 23/005

(57) ABSTRACT

A method of carrying out methodical aerial photography from an aircraft over a region involves obtaining a flight plan to methodically photograph the region, the plan including scan lines to scan the region. A current location of the aircraft is considered and if the aircraft is within a scan line, then a scan line trajectory is calculated to adhere to the current scan line. If however, the aircraft is at an end of a scan line, then a transition path is provided to transition to the next scan line. A transition path trajectory is then provided to allow the aircraft to adhere to the transition path. Operational inputs are provided to the pilot to follow the scan line or transition path; the pilot controls the aircraft using the operational inputs, typically pitch and roll, thereby to photograph the region using the flight plan.

### RELATED APPLICATION

This application claims the benefit of priority under 35 USC § 119(e) of U.S. Provisional Patent Application No. 63/437,766 filed on Jan. 9, 2023, the contents of which are incorporated by reference as if fully set forth herein in their entirety.

### FIELD AND BACKGROUND OF THE INVENTION

The present invention, in some embodiments thereof, relates to an aerophotography flight director and its use and, more particularly, but not exclusively, to the use of the flight director in more accurately following a flight plan for methodical aerophotography.

A flight director system (FDS) combines outputs from the various aircraft instruments to provide an easily interpreted display of the aircraft's flight path. The pre-programmed path, automatically computed, furnishes the pilot with the steering and other commands necessary to obtain and hold a desired path. Thus, as the aircraft deviates from the path, flight directions are given to the pilot to modify the trajectory to intercept the desired path.

A flight director differs from an autopilot in that the autopilot actually carries out the command. The flight director merely provides the commands to the pilot to carry out.

An aerophotography flight path is fundamentally different from a passenger flight. In a passenger flight the aircraft needs to be within half a mile from the planned path, deviations are handled slowly with passengers' ride comfort in mind. By contrast, while in an aerophotography mission the aircraft needs to be within a few meters of the planned path. In the aerophotography case, deviations need to be handled quickly and smoothly to keep cameras pointed in the correct direction.

The alternatives are regular 2D aerophotography flight management displays that do show the planned path and the the relative location between the aircraft and the planned aerophotography scan lines. These alternatives however do not calculate pitch and roll commands and rely solely on the pilot's experience to correct deviations on time with minimum overshoots and to navigate between the lines in an efficient and correct manner.

In greater detail, in an aerophotography flight management display, a flight plan is provided in order to methodically cover the terrain to be photographed while keeping exact height and ground location. Regular aerophotography flight management displays present the pilot with 2D information showing the aircraft position with respect to the required position. It is up to the pilot to determine the control inputs required to intercept and retain the correct trajectory. These types of aerophotography flight management systems do not calculate a required trajectory to intercept the aero-photography path. The flight management display shows the current and the next scan line and the current position of the aircraft, and the pilot is required to process the relative location between the current and the required trajectory and apply pitch and roll commands to achieve the required trajectory. This may be particularly difficult in the presence of turbulence.

Trying to fly using an aerophotography flight management display thus requires high proficiency and places a large workload on the pilot. It is hard to maintain a high level of precision in keeping to the required flight plan for long flight durations. The aircraft flight director is not connected to the macrophotography flight management display, so that the flight director does not know the flight plan, and the aerophotography flight management display is not connected to any of the aircraft's instruments.

### SUMMARY OF THE INVENTION

An aerophotography flight director provides the pilot of an aerophotography mission with pitch and roll commands to follow in order to intercept and hold the planned aerophotography path, and the path includes both planned aerophotography scan lines and transitions between the successive scan lines In embodiments the trajectory information may be superimposed on the flight plan, so that the flight director may help to follow the flight plan instead of only indicating how to follow the current course.

In embodiments, the flight director may tell the pilot which roll and pitch commands to apply in order to keep the ground track very accurately and correct deviations with minimum overshoots for the whole of the flight plan including transitions between different courses.

According to an aspect of some embodiments of the present invention there is provided a method of carrying out methodical aerial photography from an aircraft over a region, comprising:
obtaining a flight plan to methodically photograph the region, the plan including
a plurality of scan lines to scan the region;
obtaining a current location of the aircraft;
considering the current location:
   if the aircraft is within a scan line, calculating a scan line trajectory to adhere to a current scan line; and
   if the aircraft is at an end of a scan line, providing a transition path to transition to a next scan line, and calculating a transition path trajectory to adhere to the transition path;
providing operational inputs to the pilot to follow the scan line or transition path; and
controlling the aircraft using the operational inputs, thereby to photograph the region using the flight plan.

In an embodiment, the operational inputs comprise pitch and roll.

The method may involve providing a display for showing the flight plan.

The method may involve superimposing the scan line trajectory or the transition path trajectory onto the flight plan.

In an embodiment, when the aircraft deviates from the scan line then the scan line trajectory is a trajectory to intercept the scan line.

In an embodiment, when the aircraft deviates from the transition path, then the transition path trajectory is a trajectory to intercept the transition path.

In an embodiment, the scan lines are parallel aero-photography flight lines distanced apart to provide optimal photographic coverage of the region.

In an embodiment, the obtained location is a Global Navigation Satellite System location.

According to a second aspect of the present embodiments there is provided apparatus for operating an aircraft for an aerophotography flight, comprising a display configured to show a flight plan, the flight plan comprising a plurality of parallel acro-photography flight lines distanced apart to provide optimal scan coverage of a region to be photographed, and wherein the display is further configured to superimpose over the flight plan a current location and trajectory of the aircraft.

In an embodiment, display is further configured to show at least one transition path between successive ones of the aero-photography flight lines.

In an embodiment, the display is further configured to show operational inputs to correct a current trajectory to the flight plan.

In an embodiment, the operational inputs comprise pitch and roll.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified flight path diagram illustrating an exemplary transition path between two aerophotography flight lines or scan lines, according to embodiments of the present invention;

FIG. 2 is a simplified flow chart showing a procedure for using a flight director to follow scan lines and to provide and follow transition paths, in accordance with an embodiment of the present invention; and

FIGS. 3A and 3B are two views of a display showing an aircraft following a planned line and deviating from the planned line and illustrating how the flight director provides a trajectory and operational inputs to intercept and return to the planned line.

### DESCRIPTION OF SPECIFIC EMBODIMENTS OF THE INVENTION

The present invention, in some embodiments thereof, relates to a flight director and its use in aerophotography and, more particularly, but not exclusively, to the use of the flight director in a flight plan for methodical aero-photography.

A method of carrying out methodical aerial photography from an aircraft over a region involves obtaining a flight plan to methodically photograph the region, the plan including aerophotography scan lines to scan the region. A current location of the aircraft is considered and if the aircraft is within a scan line, then a scan line trajectory is calculated to adhere to the current scan line. If however, the aircraft is at an end of a scan line, then a transition path is provided to transition to the next scan line. A transition path trajectory is then provided to allow the aircraft to adhere to the transition path. Operational inputs are provided to the pilot to follow the scan line or transition path. The pilot controls the aircraft using the operational inputs, typically pitch and roll, thereby to photograph the region using the flight plan.

Embodiments may make use of technology available in modern aircraft but not available to aero-photography flight management systems.

In the present embodiments, a software module calculates the best trajectory to intercept and keep to the planned flight lines which form the aero-photography path, aerophotography generally being carried out by using straight lines to scan the region of interest. The software module determines where the aircraft is with reference to the calculated and planned trajectory, and based on the differences it calculates the needed roll and pitch changes to intersect with the trajectory. That is to say it gives the pilot the commands to achieve a transition flight path which will take the aircraft from the present straight line scanning the area of interest to join the next scan line to continue scanning the region. A display module calculates and presents to the pilot the pitch and roll changes the pilot needs to apply for keeping to the calculated trajectory to intercept the transition path and thus reach the next scan line. That is to say the module gets the aircraft from one scan line to the next, by contrast with the prior art flight display which only tells where the aircraft is with respect to the lines but does not provide a specific path to intercept the line or keep it. The location information, typically derived from Global Navigation Satellite Systems (GNSS) data, is provided, but it is up to the pilot to make use thereof.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

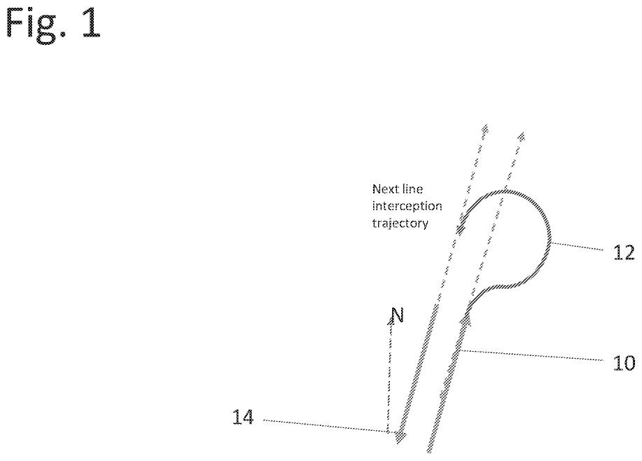

Referring now to the drawings, FIG. 1 illustrates a flight path 10 according to the present invention. The aerophotography session begins with scan line 10, which is one of a series of scans over a territory being photographed. The session continues with scan line 12, which is a further scan line in the planned flight path. The present embodiments provide flight director pitch and roll commands for holding the lines precisely. The present embodiments also provide the interconnecting segment 14, or transition path, which leads from scan line 10 to scan line 12, as will be explained in greater detail below, and provide the necessary roll and pitch information for the interconnecting segment 14 so that the pilot is able to move with ease from one scan line to the next.

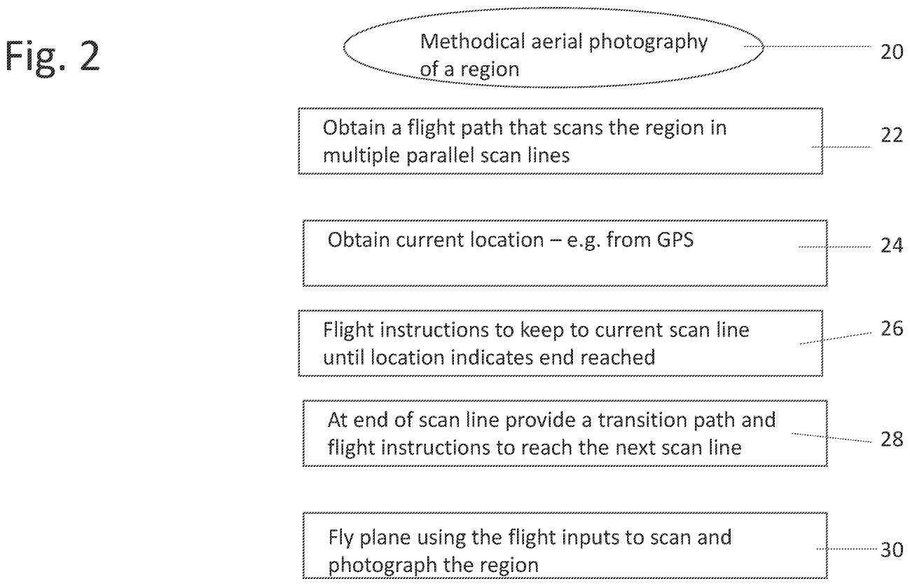

Reference is now made to FIG. 2, which is a simplified flow chart illustrating a method 20 of carrying out methodical aerial photography from an aircraft over a region.

In box 22 a flight path to scan the region that is to be photographed is obtained. Typically the flight path is made of a series of parallel scan paths at a fixed distance apart, where the distance is selected so that photographs from adjacent scan lines overlap at a fixed percentage. As will be appreciated the photographic scan will not fully cover the region if the aircraft scans along lines that are too far apart, and the session will be inefficient if the lines are too close together, yet the prior art flight directors do not provide the pilot with roll commands to assist the pilot in obtaining the correct ground location and thus distance, from the previous path. Rather the flight path as planned needs to be followed as accurately as possible for efficient methodological scanning of the region.

Regularly during the flight the current location is obtained, for example using the Global Navigation Satellite Systems (GNSS)—24, of which examples are the global positioning system (GPS), Glossnas and Baidu.

The flight director according to the present embodiments considers the current location and calculates a best trajectory to adhere to the planned flight path. If the aircraft is on a scan line then the flight director provides flight information as usual to keep the aircraft on the scan line—26. If however the aircraft reaches the end of a planned scan line then according to the present embodiments, a transition is provided—28—for the aircraft to reach the beginning of the next scan line at the correct distance from the current scan line. Such a transition may involve a turn, and as shown in FIG. 1, that turn may initially involve turning away from the next scan line, depending on the tightness of the turn that the aircraft is able to make under the current flying conditions.

The software module may calculate the path during flight. The scan lines are precalculated and loaded as a plan to the system. The transition is not loaded, but rather is calculated in real time.

Whether within a scan line or transitioning between scan lines, the flight director provides operational inputs to pilot the aircraft to follow the flight path—30. The operational inputs include pitch and roll commands to intercept and return to the planned path when deviating.

The pilot continues to control the aircraft, using the operational inputs as presented by the flight director of the present embodiments to keep to the flight path, and thus scans the region methodically.

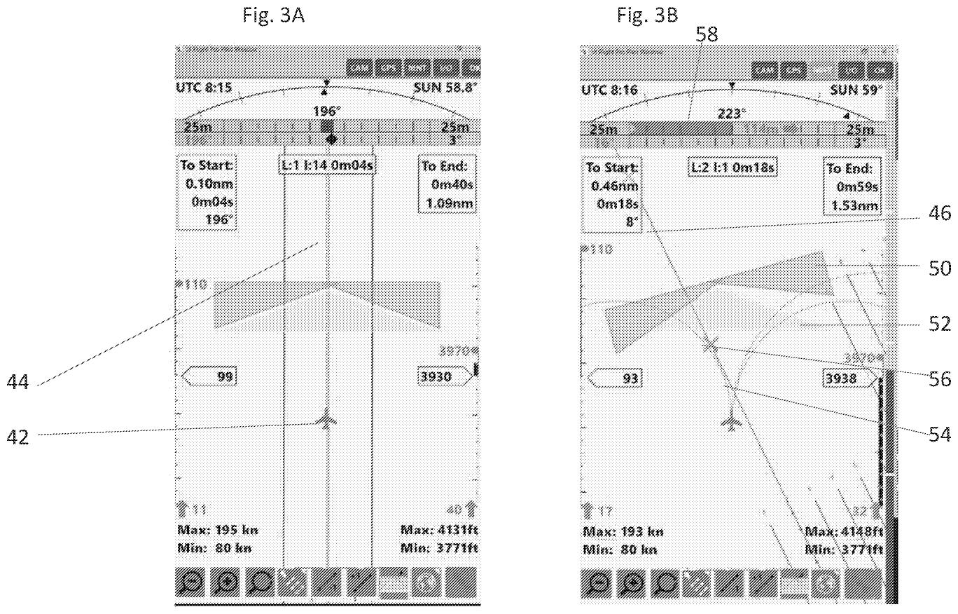

Reference is now made to FIGS. 3A and 3B which are two views of a flight director display 40. The figures illustrate the use of the Flight Director display to guide the pilot of the aero photography mission in intercepting and keeping the required flight trajectory.

The flight instructions from the flight director typically include pitch and roll instructions. The current course is obtained from the flight plan, and FIG. 3A shows the situation when the aircraft 42 is aligned with the currently intended trajectory 44. In FIG. 3B the display is shown for interception of the next line. Symbol 50 is an indicator which moves to indicate pitch and roll and the pilot is supposed to drive the aircraft such that symbol 52 aligns with symbol 50. By aligning the symbols, the aircraft may follow a trajectory that generates an efficient next line intercept with no overshoots or undershoots. Line 58 indicates horizontal deviation, between the current aircraft location and the line location that has to be corrected for.

Accordingly, when the aircraft is not on the flight path then the best trajectory is a trajectory to intercept the path. This is true whether the path is currently a scan line or whether the aircraft is transitioning to a new scan line. The present embodiments provide both the line keeping and the transition path between scan lines.

Thus the present embodiments may calculate the best trajectory for keeping and interception of next aero-photography scan line from the previous scan line.

The flight director reads the geographical location of the next scan line from the originally provided flight plan and also obtains the current location of the aircraft, say using GNSS. Based on the current trajectory the algorithm determines the best transition path trajectory to intercept the next scan line, that is the next aero-photography line in the correct ground track. The embodiments calculate, and present to the pilot, via the screen in FIG. 3B, the pitch and roll to apply in order to intercept and stay on the calculated trajectory.

Once the next scan line is intercepted the present embodiments calculate the necessary pitch and roll commands to retain the line with very high accuracy, by presenting the pilot with needed pitch and roll commands that now need to be applied.

The aircraft may also have an aero photography management display, which shows the planned path for scanning the region but is not a flight director because it does not have the updated aircraft trajectory. The present embodiments may provide for presentation of Flight Director symbols on an aero-photography management display. Although flight directors are common in modern aircraft—they are not present in aero photography flight management displays because a flight director requires calculation of needed aircraft trajectory which aero photography management systems do not do.

Thus the present flight director screen showing the aircraft trajectory may be superimposed on the planned flight path. The present embodiments may thus provide the calculation of the trajectory to intercept the transition path between the scan lines and the operational inputs required for such a trajectory.

The interface to the pilot may be a display that shows the Flight Director on top of the 2D display.

The present embodiments may thus enable accurate and efficient interception of aero photography flight lines—the scan lines. Accordingly the general load on the pilot is reduced, enabling greater effort to be spent on keeping accurately to the flight path. In particular the pilot's workload and accompanying fatigue is reduced, allowing for longer duration photography flights. In addition the need is reduced for repeat flights because of unusable results because paths were not accurately followed.

It is expected that during the life of a patent maturing from this application many relevant flight director technologies will be developed and the scope of the term “flight director” is intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”. “an” and “the” include plural references unless the context clearly dictates otherwise.

It is appreciated that certain features of the invention, which are, for clarity, described in the context of separate embodiments, may also be provided in combination in a single embodiment, and the text is to be construed as if such a single embodiment is explicitly written out in detail. Conversely, various features of the invention, which are, for brevity, described in the context of a single embodiment, may also be provided separately or in any suitable subcombination or as suitable in any other described embodiment of the invention, and the text is to be construed as if such separate embodiments or subcombinations are explicitly set forth herein in detail.

Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of carrying out methodical aerial photography from an aircraft over a region, comprising:
obtaining a flight plan to methodically photograph said region, the plan including a plurality of scan lines to scan said region;
obtaining a current location of the aircraft;
considering said current location:
if said aircraft is within a scan line, calculating a scan line trajectory to adhere to a current scan line; and
if said aircraft is at an end of a scan line, providing a transition path to transition to a next scan line, and calculating a transition path trajectory to adhere to said transition path;
providing operational inputs to the pilot to follow said scan line or transition path; and
controlling said aircraft using said operational inputs, thereby to photograph said region using said flight plan.

2. The method of claim 1, wherein said operational inputs comprise pitch and roll.

3. The method of claim 1, comprising providing a display for showing said flight plan.

4. The method of claim 3, comprising superimposing said scan line trajectory or said transition path trajectory onto said flight plan.

5. The method of claim 1, wherein, when said aircraft deviates from said scan line then said scan line trajectory is a trajectory to intercept said scan line.

6. The method of claim 1, wherein, when said aircraft deviates from said transition path, then said transition path trajectory is a trajectory to intercept said transition path.

7. The method of claim 1, wherein said scan lines are parallel aero-photography flight lines distanced apart to provide optimal photographic coverage of said region.

8. The method of claim 1, wherein said obtained location is a Global Navigation Satellite System location.

9. Apparatus for operating an aircraft for an aerophotography flight, comprising a display configured to show a flight plan, the flight plan comprising a plurality of parallel aero-photography flight lines distanced apart to provide optimal scan coverage of a region to be photographed, and wherein the display is further configured to superimpose over said flight plan a current location and trajectory of said aircraft.

10. The apparatus of claim 9, wherein said display is further configured to show at least one transition path between successive ones of said aero-photography flight lines.

11. The apparatus of claim 10, wherein said display is further configured to show operational inputs to correct a current trajectory to said flight plan.

12. The apparatus of claim 11, wherein said operational inputs comprise pitch and roll.
